(19) United States
(12) Patent Application Publication
(10) Pub. No.: US 2015/0074678 A1
(43) Pub. Date: Mar. 12, 2015

(54) DEVICE AND METHOD FOR AUTOMATING A PROCESS OF DEFINING A CLOUD COMPUTING RESOURCE

(71) Applicants: Avraham Vachnis, Tiberias (IL); Maty Grosz, Yad Hanna (IL); Nira Shavitt, Ra'anana (IL)

(72) Inventors: Avraham Vachnis, Tiberias (IL); Maty Grosz, Yad Hanna (IL); Nira Shavitt, Ra'anana (IL)

(21) Appl. No.: 14/021,366

(22) Filed: Sep. 9, 2013

(51) Int. Cl. G06F 9/50

(52) U.S. Cl. CPC G06F 9/5011
USPC 718/104

(57) ABSTRACT

An illustrative cloud computing manager device includes data storage and at least one processor that facilitates defining at least one resource to be accessible through the cloud. The processor is configured to identify descriptor information as provided by a user. The descriptor information indicates a plurality of attributes of the resource including any particular attributes that are particular to the resource. The processor is configured to automatically generate at least one of the attributes with a plurality of flavors based on the identified descriptor information. Automatically generating at least one of the attributes with a plurality of flavors according to the illustrative example reduces the amount of time and effort required by an individual who wishes to define the resource for the cloud computing system.

### TECHNICAL FIELD

This disclosure generally relates to cloud computing. More particularly, and without limitation, this disclosure relates to an automated approach to defining a new resource for a cloud computing system.

### DESCRIPTION OF THE RELATED ART

Cloud computing systems are becoming increasingly popular for a variety of reasons. One aspect of the proliferation of cloud computing is that various cloud providers are introducing proprietary protocols or standardized Application Programming Interfaces (APIs). As a result, interaction with the various cloud systems typically requires adding or updating a list of supported APIs.

For example, a cloud computing management system associated with a cloud that includes cloud elements from different providers may need up-to-date records of the APIs offered by the various elements of the system and expose those same APIs for use to the customers of the management system. Maintaining such records consumes valuable development resources.

Additionally, cloud vendor API structures typically require different parameters (compared to another vendor's parameters) to realize the same function. This presents significant challenges as using a relatively straight-forward approach to supporting such API structures may yield complicated code structures and data models that are difficult to maintain. With additional APIs and vendors entering the cloud computing market at an increasing rate, these challenges become even more daunting and currently proposed solutions become un-scalable over time.

### SUMMARY

Embodiments of this invention streamline the process of defining new resources for a cloud computing system by automating a portion of the resource creation and reducing the amount of time and effort required by a programmer.

An illustrative cloud computing manager device includes data storage and at least one processor that facilitates defining at least one resource to be accessible through the cloud. The processor is configured to identify descriptor information regarding a plurality of attributes of the resource as provided by a user. The processor is also configured to identify any particular attributes that are particular to the resource. The processor is configured to automatically generate at least one of the attributes with a plurality of different flavors.

An illustrative method of facilitating defining at least one resource to be accessible through a cloud computing system includes identifying descriptor information regarding a plurality of attributes of the resource and any particular attributes that are particular to the resource as provided by a user. At least one of the attributes is automatically generated with a plurality of different flavors, based on the identified descriptor information.

Various embodiments and their features will become apparent to those skilled in the art from the following detailed description of at least one example embodiment. The drawings that accompany the detailed description can be briefly described as follows.

### BRIEF DESCRIPTION OF THE DRAWINGS

FIG. 1 schematically illustrates an example cloud computing system including a manager device designed according to an embodiment of this invention.

FIG. 2 is a flowchart diagram summarizing an automated approach for defining a resource in the cloud computing system.

### DETAILED DESCRIPTION

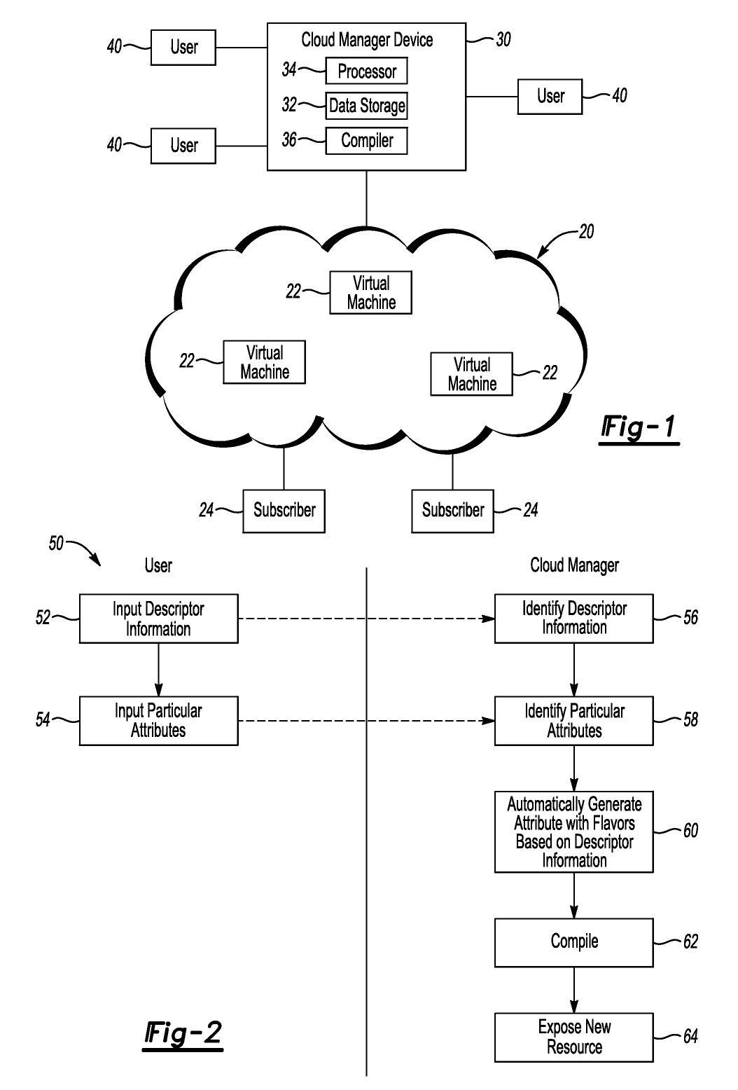

FIG. 1 schematically illustrates a cloud computing system 20 that includes a plurality of virtual machines 22. Virtual machines 22 may include resources such as processors, storage, memory or network interfaces and may reside in one or more data centers (not shown for clarity). Cloud service subscribers that utilize the virtual machines 22 for data storage or computing operations are schematically shown as subscribers 24.

A cloud manager device 30 includes data storage 32, a processor 34 and a compiler 36. Although the processor 34 and the compiler 36 are schematically shown separately for discussion purposes, some embodiments include a single processor or computing device that performs the functions of both. In some example embodiments, the processor 34 and the compiler 36 are configured to use the known JAVA programming language. The data storage 32 may include, for example, JAVA-based computer-executable instructions that the processor 34 carries out during one or more processes for managing the resources of the cloud computing system 20. The data storage 32 may also include information or records regarding the resources of the cloud computing system 20. The compiler is configured to compile data models or other programs that will be a part of or made available through the cloud computing system.

The processor 34 is configured to facilitate defining new resources in the cloud computing system 20 by at least partially automating the process. For example, the processor 34 is configured to automate at least a portion of a process of defining or introducing and exposing a new Application Programming Interface (API) in the system 20. API developers schematically represented as users 40 can expose new APIs in a more streamlined and reliable manner by interacting with the example cloud manager device 30.

FIG. 2 is a flowchart diagram 50 that summarizes an approach for defining a new resource or data model, such as an API. FIG. 2 is schematically divided into a right side and a left side to indicate the portions of the process that involve input or information from the user 40 and the portions that are completed by the processor 34 of the cloud manager device 30. In this example, the processor 34 is configured to provide an interface for the user 40 to complete the user-based steps of the example process.

Consider a data model as an example resource to be defined and included in the cloud system 20. The data model has a list of code components (e.g., classes) to be implemented, a set of Tests and Mock components to be implemented and new translator utilities to be implemented. The translator utilities are tasked, for example, with transforming business-layer requirements expressed in the data model into different flavors of cloud APIs.

A user 40 begins the process of new data model inclusion at 52 by inputting descriptor information regarding the new data model. The descriptor information indicates a plurality of attributes of the new data model in the core system. In this example, the user writes an interface having the name the user assigns to the new data model and the interface includes getters definitions for all of the properties mentioned in the previous paragraph. Example descriptor information includes a designation or name of the new data model, request/response parameters and possible error codes.

At 54 the user 40 inputs particular attribute information that indicates particular or unique attributes of the new data model. Example particular attribute information includes an indication of the cloud providers that will be supported or compatible with the new data model. When the new data model is an API, the particular attribute information will indicate the API flavors (i.e., providers) that the API will support. In this example, the user 40 maps the particular attributes (e.g., attributes that are non-standard or unique to the new data model) of the core object to each flavor data model attribute.

The particular attribute information may include special annotations that signal the compiler 36 to generate two classes. One of those classes may be referred to as a new data model class that includes all properties of the new data model, API getters and setters for these properties, constructors, builders, some other APIs for external usage (e.g., those that will be later used by JAX libraries), and a string representation of the class. The other class may be referred to as a new data model list class that is a data structure to hold the new data model classes.

At 56 the processor 34 obtains or identifies the descriptor information that was provided by the user at 52. At 58, the processor 34 obtains or identifies the particular attributes of the new data model that were provided by the user 40 at 54. The processor 34 automatically generates at least one of the attributes of the new data model with a plurality of flavors at 60 based on at least the descriptor information. In this example, the processor also uses the particular attribute information when performing the automated step schematically shown at 60.

The processor 34 is this example automatically generates all relevant artifacts and infrastructures in the core system 20. The compiler 36 generates the classes described above as the new data model class and the new data model list class.

The descriptor information such as the request/response parameters and the error codes allows the compiler 36 to generate a class named new data model mock that is useful for test settings. That information may be included in a specially designated resource file in some examples. There are known test techniques in which the data model provides mock answers to requests from the developer user.

The compiler 36 may also use information from a special resource file provided by the user as part of the descriptor information or the particular attribute information to generate an interface named new data model translator. The new data model translator interface may be useful for translating a business layer presentation of the new data model to other flavors of presentation.

In some embodiments the processor 34 uses an annotation processing technique, such as that which is known in association with JAVA programming JAVA compilers may have known basic annotation processing capabilities. The information provided by the user 40 includes an annotation of a specific type that is interpreted by the processor 34 as an instruction to generate one or more resource classes. The processor 34 uses a known technique to automatically generate at least one of the classes with a plurality of flavors from the user-specified annotation type. Once those classes have been generated, the compiler 36 can compile the code for the new data model at 62. If the results of the compiling at 62 and any error check or mock request processes are acceptable, then the new data model is defined for the cloud system 20 at 64.

The way in which the cloud manager device 30 automates a significant portion of the process of defining a new resource or data model streamlines the process, reduces the amount of developer effort required and reduces the chances of error. The process summarized in FIG. 2 and described above can reduce the amount of programming or code writing required of the developer or user by approximately 90% or more.

For example, without the cloud manager device 30 performing the disclosed technique the developer would have to manually define the new data model in the core system, define the new data model for each API flavor, map all attributes of the core data model to each flavor data model, implement the new API for each flavor, map each API flavor to the core system API, define the necessary data model tests, and implement the data model tests. If the new data model has approximately ten properties, then that manual programming process would require the developer to write approximately 1000 code lines on average. The developer would have written on the order of 700 lines of code to define the class named new data model that included all its properties, API getters and setters for those properties, constructors, builders, some other APIs for external use, and string representations of the class. Another 100 lines of code would be needed for the class named new data model list. The developer would also have to write another 300 or 350 lines of code for the new data model mock class. The new data model translator interface would have required another 20 lines on average.

By contrast, with the cloud manage device 30 operating as described above the developer may only need to write an average of less than 100 lines of code for the interface. For example, approximately 60 lines of code may be sufficient to accomplish the steps schematically shown at 52 and 54 in FIG. 2.

The preceding description is illustrative rather than limiting in nature. Variations and modifications to the disclosed examples may become apparent to those skilled in the art that do not necessarily depart from the essence of the contribution to the art provided by the disclosed embodiments. The scope of legal protection can only be determined by studying the following claims.

We claim:

1. A cloud computing manager device, comprising:
a data storage; and
at least one processor configured to facilitate defining at least one resource to be accessible through the cloud by
identifying descriptor information as provided by a user, the descriptor information indicating a plurality of attributes of the resource including particular attributes that are particular to the resource, and
automatically generating at least one of the attributes with a plurality of different flavors based on the identified descriptor information.

2. The device of claim 1, wherein
the at least one resource is an application programming interface (API);
the descriptor information comprises API descriptor information;
the particular attributes comprise information indicative of API flavors to be supported by the API.

3. The device of claim 2, wherein the processor is configured to generate a plurality of artifacts and infrastructures based on the descriptor information and the API flavors.

4. The device of claim 2, wherein the API descriptor information comprises
a name of the resource,
at least one request parameter,
at least one response parameter, and
at least one error code.

5. The device of claim 2, wherein the API flavors correspond to cloud service providers.

6. The device of claim 1, wherein
the resource comprises a data model;
the descriptor information comprises a plurality of code components, a plurality of test components, and a plurality of mock request components;
the particular attributes comprise translator utilities configured for transforming business-layer requirements expressed in the data model into a flavor corresponding to a selected provider.

7. The device of claim 1, wherein the descriptor information
defines an interface; and
comprises getters definitions for a plurality of properties including a plurality of code components, a plurality of test components, and a plurality of mock request components.

8. The device of claim 7, wherein the descriptor information that identifies the interface describes at least one resource class.

9. The device of claim 1, comprising
a compiler that is configured to
perform annotation processing including
recognizing a field annotation provided by the user;
automatically generating a plurality of classes based on the field annotation; and
compile the resource,
the resource being ready for exposure on the cloud system once the resource has been compiled.

10. A method of facilitating defining at least one resource to be accessible through a cloud computing system, comprising the steps of:
identifying descriptor information as provided by a user, the descriptor information indicating a plurality of attributes of the resource including particular attributes that are particular to the resource; and
automatically generating at least one of the attributes with a plurality of flavors based on at least the identified descriptor information.

11. The method of claim 10, wherein
the at least one resource is an application programming interface (API);
the descriptor information comprises API descriptor information;
the particular attributes comprise information indicative of API flavors to be supported by the API.

12. The method of claim 11, comprising generating a plurality of artifacts and infrastructures based on the descriptor information and the API flavors.

13. The method of claim 11, wherein the API descriptor information comprises
a name of the resource,
at least one request parameter,
at least one response parameter, and
at least one error code.

14. The method of claim 11, wherein the API flavors correspond to cloud service providers.

15. The method of claim 10, wherein
the resource comprises a data model;
the descriptor information comprises a plurality of code components, a plurality of test components, and a plurality of mock request components;
the particular attributes comprise translator utilities configured for transforming business-layer requirements expressed in the data model into a flavor corresponding to a selected provider.

16. The method of claim 10, wherein the descriptor information
defines an interface; and
comprises getters definitions for a plurality of properties including a plurality of code components, a plurality of test components, and a plurality of mock request components.

17. The method of claim 16, wherein the descriptor information that identifies the interface describes at least one resource class.

18. The method of claim 10, comprising
performing annotation processing including
(i) recognizing a field annotation provided by the user, and
(ii) automatically generating a plurality of classes based on the field annotation; and
compiling the resource,
wherein the resource is ready for exposure on the cloud system once the resource has been compiled.
